(19) United States
(12) Patent Application Publication
(10) Pub. No.: US 2020/0271782 A1
(43) Pub. Date: Aug. 27, 2020

(54) Aft-Looking Sonar

(71) Applicant: Airmar Technology Corporation, Milford, NH (US)

(72) Inventors: Kenneth D. Rolt, Westford, MA (US); Eric J. Beiswenger, Amherst, NH (US)

(21) Appl. No.: 16/652,363

(22) PCT Filed: Oct. 4, 2018
(86) PCT No.: PCT/US2018/054406

§ 371 Date: Mar. 30, 2020

Related U.S. Application Data
(60) Provisional application No. 62/569,343, filed on Oct. 6, 2017.

(51) Int. Cl. G01S 15/96; G01S 15/58; G01S 15/42; G01S 15/66; G01S 7/539

(52) U.S. Cl. CPC G01S 15/96; G01S 15/582; G01S 7/539; G01S 15/66; G01S 15/42

(57) ABSTRACT

In some embodiments, the methods (and systems) may generate, from the aft direction of a marine vessel, one or more pulses of sound. The methods (and systems) may receive, at the aft direction of a marine vessel, one or more echoes, in response to the generated one or more pulses of sound interacting with one or more physical objects. The methods (and systems) may perform an analysis on the received one or more echoes based upon the generated one or more pulses of sound. The analysis may be performed based upon space-time Doppler filtering. The physical objects may include game fish. The analysis may be based upon the size and/or location of atleast one of the one or more physical objects. The analysis may include acoustic detection, localizing, tracking, and/or sizing of at least one of the one or more physical objects.

### RELATED APPLICATION

This application claims the benefit of U.S. Provisional Application No. 62/569,343 filed on Oct. 6, 2017. The entire teachings of the above application are incorporated herein by reference.

### BACKGROUND

Sonar is frequently used in marine vessels. Sonar uses sound propagation to communicate with or detect objects on or under the surface of water. Existing sonar techniques include active sonar, which includes emitting pulses of sound and listening for echoes.

However, the marine industry lacks existing active sonar systems that perform active sonar detection efficiently and effectively in the aft of a moving marine vessel.

### SUMMARY

In some embodiments, the methods (and systems) may generate, from the aft direction of a marine vessel, one or more pulses of sound. The methods (and systems) may receive, at the aft direction of a marine vessel, one or more echoes, in response to the generated one or more pulses of sound interacting with one or more physical objects. The methods (and systems) may perform an analysis on the received one or more echoes based upon the generated one or more pulses of sound.

According to some embodiments of the methods (and systems), the analysis may be performed based upon space-time Doppler filtering to detect range and direction of at least one of the one or more physical objects. The one or more physical objects may include game fish. The one or more physical objects may include a plurality of physical objects including one or more target objects and one or more reference objects.

According to some embodiments of the methods (and systems), the analysis may be based upon at least one of the size and location of at least one of the one or more physical objects. The analysis may include one or more of acoustic detection, localizing, tracking, and sizing of at least one of the one or more physical objects. The analysis may be based upon estimating depth of at least one of the one or more physical objects. According to some embodiments of the methods (and systems), the methods (and systems) may display live video of at least one of the one or more physical objects. The methods (and systems) may display at least one of depth and temperature of a dredge attached to the marine vessel. The methods (and systems) may generate the one or more pulses of sound from at least one of below and astride the marine vessel. The methods (and systems) may generate the one or more pulses of sound from first and second sound sources. The second sound source may be connected to a dredge connected to the marine vessel.

In some embodiments, the systems (and methods) may include at least one processor coupled to associated memory, the at least one processor configured to implement one or more of a generation module, a receiving module and/or a processing module. In some embodiments, the systems (and methods) may include the generation module configured to generate, from the aft direction of a marine vessel, one or more pulses of sound. In some embodiments, the systems (and methods) may include the receiving module configured to receive, at the aft direction of a marine vessel, one or more echoes, in response to the generated one or more pulses of sound interacting with one or more physical objects. In some embodiments, the systems (and methods) may include the processing module, configured to perform an analysis on the received one or more echoes based upon the generated one or more pulses of sound. According to some embodiments of the systems (and methods), the analysis may be performed based upon space-time Doppler filtering to detect range and direction of at least one of the one or more physical objects.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flow diagram illustrating an example method (or system), according to some embodiments of the present disclosure.

FIG. 2A is a system block diagram of a sonar architecture, according to some embodiments of the present disclosure.

FIGS. 2B-2C illustrate boat placement, pointed aft, according to some embodiments of the present disclosure.

FIGS. 3A-3B are graphs of Range Doppler filtering, according to some embodiments of the present disclosure.

FIGS. 4-6 are flow diagrams, illustrating an example method (or system), according to some embodiments of the present disclosure.

FIG. 7 illustrates a plot of target strength (TS), according to some embodiments of the present disclosure.

FIG. 8 illustrates a maximum broadside target strength (TS), according to some embodiments of the present disclosure.

FIG. 9 illustrates a game fish (target object) having various positions (distances) with respect to a dredge with sensors that is connected to a boat, and the resulting target strength, according to some embodiments of the present disclosure.

FIG. 10 illustrates a computer network (or apparatus, or system) or similar digital processing environment, according to some embodiments of the present disclosure.

FIG. 11 illustrates a diagram of an example internal structure of a computer (e.g., client processor/device or server computers) in the computer system (and apparatus) of FIG. 10, according to some embodiments of the present disclosure.

### DETAILED DESCRIPTION

A description of example embodiments follows.

The teachings of all patents, published applications and references cited herein are incorporated by reference in their entirety.

Some embodiments are directed to an AFT-Looking Sonar, which may include sonar mounted to a marine craft (preferred is a surface craft, but it may be otherwise), aimed in the aft-direction. Sonar may be mounted on a vessel door, stern, or aft of a vessel, or in any other manner known to one skilled in the art. According to some embodiments, the stern and aft are at the back or tail portion of the vessel, and stern is outside or offboard, while the aft is inside or onboard. The purpose is to use active sonar to Detect, Localize, Track and/or Classify (DLTC) objects behind the marine craft. The target objects for this system may be a towed group of fishing lures that are deployed from the stern, along with the large fish that attack the lure(s). In marine parlance these are called fishing dredges.

In the art, there are at least two kinds of dredges:

1. those that drag the bottom to catch (scoop up) shellfish, and

2. the other kinds that stay in the water column or near the surface and have lures and fishing hooks attached. Some embodiments may use active sonar to detect, localize, track and/or classify (DLTC) objects on the second kind of dredge, and the speeds are usually from 1 to 5 knots.

Examples existing in the art of underwater videos showing a dredge being towed at low speed, and being chased by some very large predatory game fish. Other example videos known in the art show how dredges are deployed from a boat.

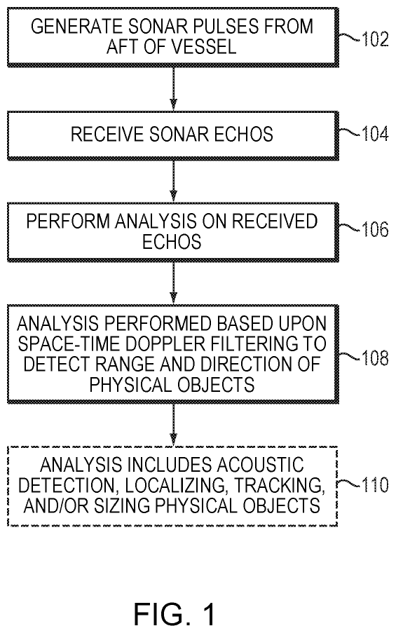

FIG. 1 is a flow diagram illustrating an example method (or system), according to some embodiments of the present disclosure.

As illustrated in FIG. 1, in some embodiments, the methods (and systems) may generate 102, from the aft direction of a marine vessel, one or more pulses of sound. The methods (and systems) may receive 104, at the aft direction of a marine vessel, one or more echoes, in response to the generated one or more pulses of sound interacting with one or more physical objects. The methods (and systems) may perform an analysis 106 on the received one or more echoes based upon the generated one or more pulses of sound. As illustrated in FIG. 1, according to some embodiments of the methods (and systems), the analysis may be performed 108 based upon space-time Doppler filtering.

The one or more physical objects may include predatory game fish. The analysis may be based upon the size of at least one of the one or more physical objects. The analysis is based upon the location of at least one of the one or more physical objects.

As illustrated in FIG. 1, the analysis may optionally include one or more of acoustic detection, localizing, tracking, and sizing 110 of at least one of the one or more physical objects. The one or more physical objects may include a plurality of physical objects including one or more target objects and one or more reference objects. The analysis may include one or more of acoustic detection, localizing, tracking, and sizing of at least one of the one or more target objects.

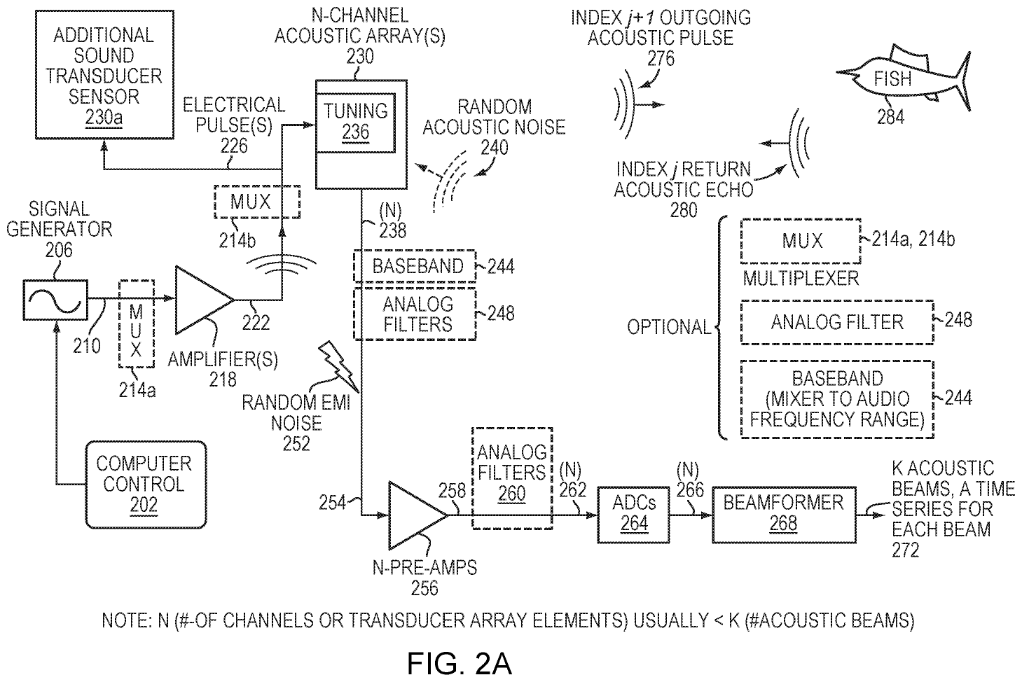

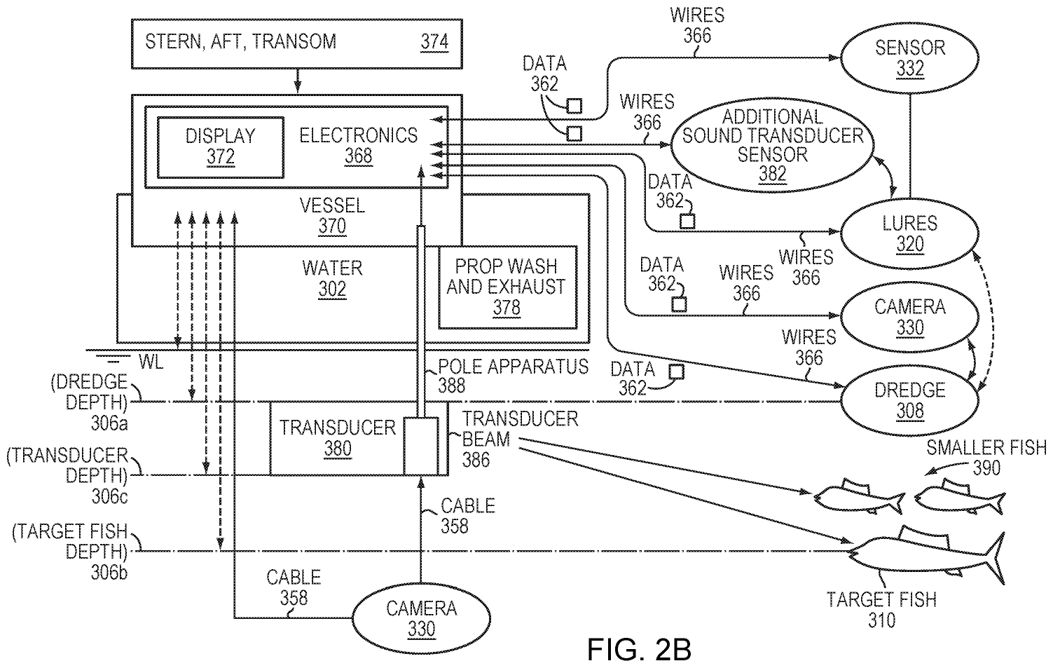

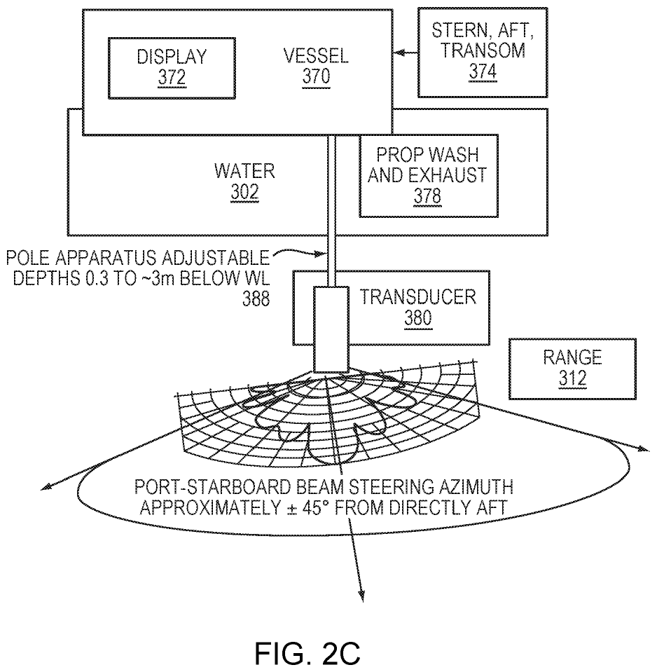

FIG. 2A is a system block diagram of a sonar architecture that may be included in the methods (and systems), according to some embodiments of the present disclosure. The main elements of FIG. 2A are the computer control 202, the signal generator 206, the N-channel acoustic array(s) 230, and the beamformer 268. FIG. 2A includes an optional second source transducer array 230a.

As illustrated in FIG. 2A, some embodiments may generate 276 one or more pulses of sound through generating acoustic beams 272 based upon a signal generator 206. The signal generator 206 (including but not limited to any reference to “signal generator” herein) may create time series waveform parameters based on Computer control 202. Time series may have frequency content bandwidth, where bandwidth (BW) =f₂−f₁, time-varying amplitude A(t) of the pulse voltage, and duration T to optimally work with the combined electrical tuning (inductors, capacitors, transformers) and Acoustic transducer array 230. Pulse Repetition Frequency (PRF), i.e. pulse rate, may also be commanded by computer control 202, and usually initialized by default and then user-adjustable based on maximum desired operating range. Pulse Repetition Period PRP=1/PRF.

Computer control 202 (including but not limited to any reference to “computer control” herein) may provide or control wave parameters to the signal generator 206 such as modulation, bandwidth, start and end frequency, pulse duration, pulse repetition frequency (PRF), amplitude, duty cycle, as well as calculate, filter, estimate and use noise estimates, and/or detection parameters. Preferred frequencies may be ultrasonic (greater than 20 kHz) for small wavelengths and narrow beams but less than 1 MHz to have useful range in marine environments. The signal 210 output from the signal generator 206 may be multiplexed 214a on its way to one or more amplifiers 218. The one or more amplifiers may output one or more electrical pulses 222 that may pass through 226 a multiplexer 214b and be transducted into sound by N-channel acoustic arrays 230 that may perform tuning 236 on the electrical pulses 226. The one or more N-channel acoustic arrays 230 (including but not limited to any reference to “arrays” herein) may output one or more signals 238 (susceptible to random acoustic noise 240 and random EMI noise 252) that may be mixed to baseband 244 and analog filtered 248, the filtered output 254 being forwarded to pre-amplifiers 256. Electromagnetic interference (EMI) 252 can occur anywhere in the signal path but it is shown between transducer array 230 and preamps 256. The output 258 of the preamplifier 256 may pass through analog filters 260 before being received 262 by one or more analog-to-digital converters (ADC, element 264). In FIG. 2A, the beamformer 268 (including but not limited to any reference to “beamformer” herein) may receive the digital output 266 of the ADC 264 and may generate K acoustic beams 272, including a time series for each K-th beam. According to some embodiments, the beamformer 268 may be a delay-sum Beamformer using sampled time series data, or may be a conventional FFT Beamformer, or may be an Adaptive Beamformer (in either time-domain or frequency-domain)

The acoustic array 230 may be used to generate output acoustic pulses 276 to one or more physical objects 284, and an acoustic echo 280 may be received based upon interaction with the one or more physical objects 284. Sizing, or determining a size of the one or more physical objects 284, may be achieved based upon the magnitude of the received echo 280.

Although not shown in FIG. 2A, it is understood by one skilled in the art that T/R (T/R or=transmit/receive) switches (including but not limited to diodes, relays, and the like) may be used in conjunction with the hardware of FIG. 2A.

As illustrated in FIG. 2B, an additional sound sensor (or additional sound transducer or additional sound transducer sensor) 382 (also 230a of FIG. 2A) may be placed on the dredge 308 so that it serves as a towed source (along with the acoustic targets 310). The additional sound sensor 382 may be mounted on the vessel 370 directly (as shown in FIG. 2B), mounted as part of the fishing dredge 308, or separately towed from the dredge 308, or any combination thereof.

The additional sound sensor 382 provides multiple advantages. The additional sound sensor 382 is advantageous in that it is less influenced by movement (pitch, heave, yaw etc.) of the vessel 370. As such, the additional sound sensor 382 is a more stable device for the transmission and reception of sonar pulses. The additional sound sensor 382 may be advantageous in heavy sea conditions or for smaller vessels 370 for fishing. In addition, the additional sound sensor 382 also provides the opportunity for sensor data fusion (a boat-mounted sensor 380 and a towed sensor 382) which can reduce false alarms and clutter by having two sensor systems (boat sensor 380, towed sensor 382) that look at the same target (game fish) 310 from two different ranges, with two different potential Doppler shifted echoes. Yet further, the towed sensor 382 is further away from the vessel 370 (in depth) than the wake and prop wash (which buoyantly moves upwards with time) 378, so the towed sensor 382 may be more immune to clutter echoes of the wake and prop wash 378.

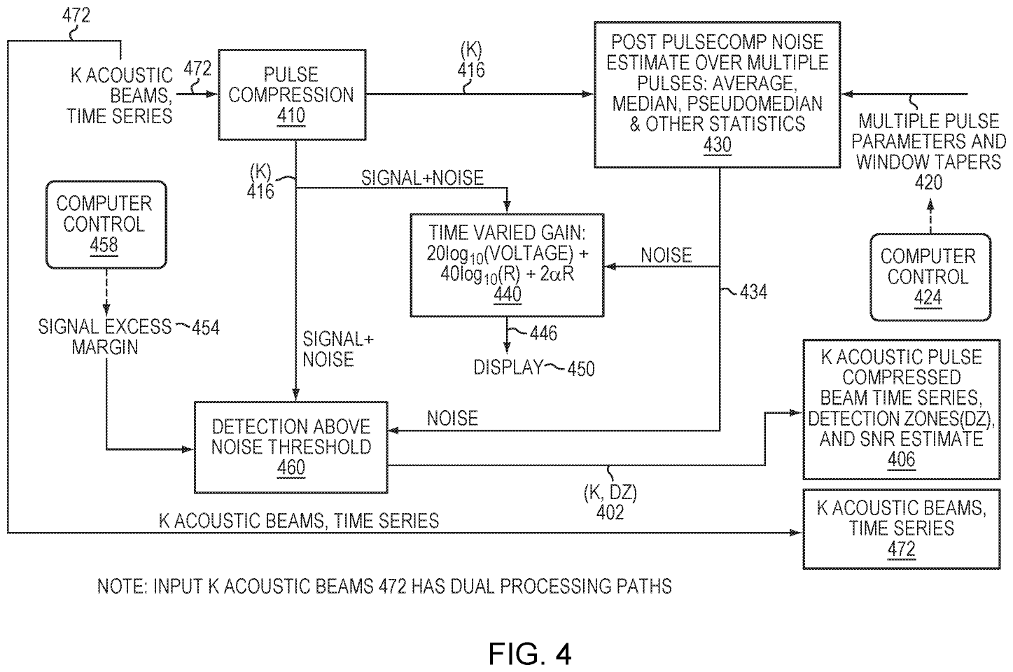

The additional sound transducer sensor 382 may be implemented as any of a single transducer, an acoustic split-beam sensor, and an acoustic phased array, or any combination thereof. The same signal processing chain (of FIG. 2A, and FIGS. 4-6) for the boat-mounted sensor 380 (also element 230 of FIG. 2A) may be utilized in-part or in-whole for this additional sensor 382. The additional sensor 382 may work in the same frequency band as the boat-mounted sensor (or transducer) 380, or in a different band to exploit frequency diversity. The towed additional sensor 382 may be used in concert with the boat-mounted sensor 380, or each may operate alone.

The additional sound transducer sensor 382 of FIG. 2B may be used at a lower power setting, if desired, than the stern-mounted (or aft-mounted) transducer (or transducer array) 380 because the additional sound transducer sensor 382 is much closer to the target fish 310. The additional sound transducer sensor 382 may also extend the tracking range 312 (of FIG. 2C) behind the boat (or vessel) 370 because the additional sound transducer sensor 382 is closer to the target fish 310 than the transducer 380. The additional sound transducer sensor 382 may also be a wide beam to match the angular coverage (or Field-of-View, FOV) of the stern-mounted (or aft-mounted) transducer 380. The transducer 380 or the additional sound sensor (or additional sound transducer) 382 may be used for receive (to get a dredge-target range 312 of FIG. 2C). As a receiver, the additional sound transducer 382 may hear less boat and engine noise because the additional sound transducer 382 is not in close proximity to the boat 370. In addition, the stern-mounted (or aft-mounted) transducer array 380 may be used to receive the echoes from the additional sound transducer sensor 382, thus providing additional target bearing measurements. Also, the additional sensor 382 may be used at a different frequency (lower, or higher, or both) than used by the stern-mounted transducer array 380. This lower frequency may provide frequency diversity, thereby overcoming target echo fading when the target 310 presents a scattering null. This may assist sizing and tracking of target fish 310. The additional sound transducer 382 may use wires 366 connecting the additional sound transducer 382 to the boat electronics 368, and the boat electronics 368 may be altered to drive the additional sound transducer 382, as well as to receive and process the added data that the additional sound transducer 382 provides to the electronics 368.

In some embodiments, wires 366 may be comprised of one or more electrical conductors that may include but are not limited to including copper material. In some embodiments, wires 366 may be comprised of optical fibers. In some embodiments, wires 366 may be comprised of optical fibers and one or more electrical conductors. The boat electronics 368 may include one or more electrical-to-optical (EO) or optical-to-electrical (OE) converters as transmitters or receivers. Wires 366 may be used to implement a portion of or all of the signal flow shown herein in FIGS. 2A, FIGS. 2B-C, and FIGS. 4-6.

The boat electronics 368 may transmit data or signals along the wires 366 to one or more devices, receive data or signals along the wires 366 from one or more devices, and provide power along the wires 366 to the one or more devices. The signals may include echo data time series. The one or more devices may include but are not limited to include one or more transducers 380 (sensor, source, or both sensor and source), additional sound sensors 382, cameras 330, and dredges 308. As such, the wires 366 may be unidirectional, bidirectional, or multiplexed with any of power, data, and fiber connections.

In addition to the dredge 308 being equipped with acoustic targets, the dredge 308 may also be equipped with one or more temperature and depth sensor(s) 332, and the data 362 sent back to the boat electronics 368 by wires 366. This may allow the boat electronics 368 to display both the dredge depth 306a and temperature to the user, as well as to speed-up the boat 370, or to slow down the boat 370, so that the slightly negatively buoyant dredge rises or sinks, thus performing depth-wise station keeping along a thermocline temperature defined by the user. These may be useful because game fish 310 often feed along certain thermocline regions, because smaller fish 390 congregate on them.

In some embodiments, methods or systems may add target depth estimation by the use of split aperture (e.g., split beam) techniques. The aft-looking phased array 380 may have beams 386 formed by a processor (located in the transducer 380 or electronics 368), and the two-way range may provide azimuth angle and range to isolated targets (e.g., an attacking game fish 310). In addition, target depth 306b may be estimated by phase methods using an array of receive elements segmented vertically. These elements could be part of the existing phased array 380 (also 230 of FIG. 2A), or may be more simply a second set of vertically displaced receive elements (included in or connected to element 230 of FIG. 2A). In an embodiment, split aperture or split beam may provide a vertical (depression/elevation, also known as D/E) angle estimate means. Split aperture or split beam may also be performed using a two-dimensional (2D) planar array 330 that can steer in both azimuth and in D/E.

In some embodiments, methods or systems may add a camera 330, either for natural light video or laser electro-optic (EO) illumination, or both, the camera 330 being added to the sound head (where the transducer 380 is located) or to the dredge 308 (a towed lure spread). The camera 330 may provide (e.g., display) live video if the targets 310 are close enough to be seen, and the camera 330 may be powered by energy from the boat 370, via cable 358, and the video data may be sent back to the boat 370 by wires 366.

Embodiments are capable of detecting, localizing and/or tracking dredges using acoustic transducers mounted near or to the stern of a boat. The acoustic array used for this is an N-channel phased array 330. It is oriented so that it can steer beams from port to aft to starboard (or the converse) by electronic means known in the art of beamforming, and that vertical steering (in depth) can be accomplished by interferometry from two or more vertically-spaced transducers as part of the array assembly. Phased array may also be used to perform 3D beamforming, an expensive method known in the art. Range 312 (of FIG. 2C) may be determined from time-of-flight, and azimuth and elevation angles may be from beamforming and/or interferometry. This provides localization behind the boat 370.

Embodiments are capable of detecting, localizing and/or tracking dredges using ordinary high-Q transducers, however wideband or broadband transducers that use chirp and other broadband waveforms may have improved performance. Detecting, localizing and/or tracking may be performed with a single transducer assembly (with multiple elements for beamforming), or from a transducer system having both a wide-angle transmit transducer and a phased array receiver transducer. The transmit transducer can be mounted in the same package as the receiver array, but they also could be mounted in separate packages, which may cost more but there is a slight system performance advantage to doing so.

Transducers 380 are below the waterline when in use. Depending on the stern 374 of the boat 370, the transducers 380 may be mounted to the stern if they are far enough from the prop and exhaust wash 378, but the preferred embodiment is on a retractable linkage that allows deployment at a depth 306c lower than the one or more propellers or other propulsers. The retraction means may be pole-type, or multibar linkage, or any other robust system for electrically, manually, pneumatically or hydraulically raising and lowering the one or more transducers. The one or more transducers 380 may also have a controlled pitch adjustment at the end of the linkage for system fine depression and elevation tuning as a function of the vessel's trim and speed.

In some embodiments, the dredge 308 is deployed at a depth (or location) 306a below, astride, or both below and astride the vessel 370. In some embodiments, the transducer 380 is deployed at a depth (or location) 306c below, astride, or both below and astride the vessel 370. In some embodiments, the transducer 380 is deployed at a depth (or location) 306c below, astride, or both below and astride at least one of the prop wash and exhaust in the water 302, thereby improving acoustic visibility of clean water 302 aftward and improving system capability. In contrast, existing approaches have indiscriminant mounting to the transom 374 without regard for where the prop wash exhaust are, resulting in reduced system capability.

Some embodiments may retract the wet-end components (e.g., transducer or transducers 380, pole 388, arms, articulation means, and other wet-end components known to one skilled in the art) either upwards towards the surface, or upwards and completely out of the water 302, resulting in lower hydrodynamic drag on the wet-end components. In some embodiments, the wet-end components may be retracted while the vessel 370 is transiting to or from a fishing area. Some embodiments may include a corresponding pole 388 or articulation mechanism as part of a system.

The very dynamic wake and/or exhaust created by the boat 370 may be a challenge, and so are surface waves behind the boat 370, both of which may be remedied by the present disclosure. Bottom echoes may also be challenging if the water is shallow enough. But the present disclosure can overcome bottom echoes by using Doppler filtering, because the dredge 308 targets may have zero or near-zero Doppler with respect to the boat 370, and the wakes, exhaust, bottom and/or waves are almost entirely negatively Doppler-shifted, while the game fish 310 that are desired to be caught may be at zero Doppler while they are hunting and then positive Doppler shift when they attack the dredge 308.

In some embodiments, the boat 370 may include a display showing the dredge targets (a known number), the target depth(s), very little wake, very little exhaust plume, very little bottom echoes, few surface wave echoes, and when they arrive game fish 310 attacking the dredge 308. The display may include a sector image showing, for example, the 120° sector behind the boat 370, and out to a distance of ˜150 m, and from near horizontal to perhaps 45° downward.

Some embodiments may add acoustic enhancement targets onto the dredge 308 to improve their acoustic visibility, while also not interfering with the lures. The game fish 310 may be uncooperative but they are also very dynamic and have reasonable acoustic target strengths, so they can also be identified and imaged at the periphery of the sector-scene, as they move towards the dredge 308 which is closer to the center of the display.

In stark contrast to the present disclosure, at present there is no existing approach that provides real-time situational awareness of the fishing gear behind the boat, at ranges too long for optical methods (camera). Existing approaches have asserted that the boat wake may make situational awareness at ranges too long for optical methods unlikely to work from a boat-mounted sonar. However, successful experiments performed on some embodiments have shown that such methods do work (in accordance with the systems and methods of some embodiments herein) as demonstrated with data. Also in stark contrast to the present disclosure, existing approaches also do not use lure-type fishing dredges with sonar.

In addition, another novel aspect of the present disclosure is aft-looking imaging sonar. Existing approaches use downward-looking and forward-looking sonar imaging, but not aft-looking from the combined use of wideband sonar, phased array, vertical interferometry, and/or electro optic (EO) imaging.

Introduction

Some embodiments may include a system for the AFT acoustic detection, localization, tracking and classification of predatory marine game fish 310 (tuna, sailfish, billfish e.g.), as well as detection, localization, tracking of a towed lure spread (dredge), from a marine vessel (usually a boat). The system may use a combination of energy detection, Doppler detection and filtering (surface-, bottom-, and wake-turbulence clutter), and target TMA (Time Motion Analysis) to extract fish parameters (detection, location and depth, speed, direction vector, and aspect-corrected size estimate) and cueing of accessory narrow field-of-view optical (vision, lidar or very high frequency acoustic) imagers.

Sound attenuation varies with frequency: approximately f² attenuation. The acoustic frequency for optimum system performance may be influenced by attenuation, but it also varies by the need for small acoustic wavelengths to obtain fine spatial resolution. These two factors are inversely related, so this becomes an engineering system tradeoff

Embodiments are capable of operating near 160 kHz for convenience because of commercially-available small circa 150 kHz linear 8-element phased transducer array usually used for swath sonar imaging that is small enough to be mounted on a pole from the transom 374 and aimed aft-wards and below the waterline. Embodiments are capable of using a commercial sounder (a combined amplifier, processor and display) with this transducer to obtain aft-looking sonar echoes. Such commercial systems are intended for downward and swath imaging during forward boat movement, within a typical angular sector of ±60° from nadir. Herein, nadir is defined as the direction pointing directly below a particular location. Some embodiments have instead rotated the transducer array so that it looks aft, with a wide port-aft-starboard field-of-view.

Some embodiments may include an electro-optical (EO) laser scanner range-finder. According to some embodiments, such an EO laser scanner may work better than a camera provided good optical clarity, and may allow acoustic-cueing and real-time optical display of fish species.

Some embodiments preferably use a field-of-view to ±45° from directly aft, because these are directions that are more aft than they are port or starboard. As configured by some commercial swath systems, and using the phased array transducer 380, some embodiments can obtain echoes beyond 300 m range, so a higher frequency may be used in a dredge fishing detection system because there is no need to look aft that far. A max range of approximately 100 m may be adequate, which means the frequency could be increased, or the power reduced (from 1 kW), or both. This means there a considerable increase in frequency could be made, so long as the power handling ability is acceptable.

Some embodiments may allow dual-band or tri-band frequency systems. According to some embodiments, the band around 150 kHz may be used to obtain coarse low-resolution at longer ranges, and higher resolution at the third harmonic band centered at 450 kHz for regions closer to the boat. Examples would be the dual-frequency and tri-frequency bar piezoelectric ceramics where the lowest-, mid- and highest-frequencies are respectively from the length-mode that couples into thickness motion, the width-mode that couples into thickness motion, and of course the thickness mode. Likewise, the fundamental radial mode for a disk piezoelectric ceramic couples into the thickness direction for a low frequency, as well as having an odd-harmonic series of thickness modes that are already aligned to radiate sound effectively. That also means that small segments of ceramics can be aligned into the footprint of a preferred shape to create the one or more beamwidths of choice for each vibration mode, thereby allowing the use of many small low-cost ceramic parts, in place of high-cost single bars or disks.

Dredges are commercially made and sold for sport fishing. These are umbrella-like spreads of boat-towed fishing lures 320 designed to mimic a school of bait fish 390. The dredges 308 do not have, however, any deliberately-affixed acoustic targets because they are not used in concert with a purpose-built aft-looking acoustic system. In some embodiments, by adding one or more acoustic reference targets 320 to the dredge, the dredge may be more easily detected and localized from an aft-looking sonar, and then seen on the sonar display. According to some embodiments, because these acoustic reference targets 320 are of known physical size, their acoustic target strength (TS), is precisely known a priori and used as an in-situ known reference with which the echo of a predatory game fish, that attacks the dredge lures 320, may be compared. Tracking and speed estimates, along with the aspect-dependent echo strength, allows for an estimate of the broadside acoustic target strength (TS) thereby estimating the maximum fish size and length.

According to some embodiments, the acoustic target(s) 320 may be made of differing sizes with, for example, large, medium and small using a sphere or spherical cap molded design with a surrounding hydrodynamic fairing. These strong artificial acoustic targets 320 can also be used as acoustic guide star, like the laser guide star used in adaptive optics, to help correct to sharpen acoustic images when used with phased array transducers and to correct for micro-multipath and the resulting phase aberrations that result.

According to some embodiments, game fish 310 may have acoustic target strengths, TS_{fish}, that are largest at broadside, and are time-varying for approaching fish. Max Doppler roughly occurs when TS is frontal, and maximum TS when Doppler is near zero, and with a range of Doppler shifts and echo strengths during the complicated fish motion as it attacks the dredge 308. These can be used in a physics- and math-based model for the fish that can extract the most probable fish size and length.

Some embodiments may include size and frequency effects of the transducer 380: higher frequency provides narrower beam resolution; higher frequency also provides a larger frequency base for fish positive Doppler shift (up-Doppler) and fish Doppler bandwidth hence easier separation with down-Doppler clutter. Doppler shifts in the acoustic frequency occur because there is relative movement between the sonar on the moving boat 370, and the objects 320 the sound encounters.

The marine bottom, if close enough to have a measurable echo, may move away from the sonar so it has a down-Doppler shifted echo. The turbulent boat wake and prop wash 378 is a weak sound scatterer, but any echoes from it would be down-Doppler because they also move away from the boat 370. The dredge and dredge-mounted acoustic reference targets have close to, or identical to, zero-Doppler because they are held at a fixed distance from the boat during use. A game fish approaches the boat 370, initially from the sides or from aft 374, and eventually from aft 374 as they chase the dredge. So they might have an initial weak up-Doppler but will eventually have an up-Doppler echo. According to some embodiments, signal processing may be employed to sort out such issues. Such signal processing may include but is not limited to including Doppler filtering (FFT; filter into separate bands: down Doppler, zero Doppler, and up-Doppler; then IFFT) followed by range compression. In another embodiment, range compression for target detection may be accomplished in a parallel signal path than the Doppler filtering path.

There is a need to control the acoustic main and side lobes towards the surface and surface reverb. This is a matter of transducer and array system design, possibly using an asymmetric vertical beam pattern. In some embodiments, this allows a spatial reduction of clutter energy prior to Doppler spectral filtering. The vessel wake, and/or, the bubbly prop wash 378 from the boat 370, is the main source of acoustic clutter for an aft-looking system. In vessels used for fishing the boat size and boat speed are both usually small enough such that the acoustic transducer can send and receive acoustic waves beneath the wake and prop wash. At longer ranges from the boat, the prop wash will rise with the engine exhaust and that also helps allow the acoustic waves to pass beneath the wake and wash contrail. This allows acoustic visibility of the dredge lures, affixed dredge targets, and attacking game fish 310. Various means of affixing an aft-looking sonar are known in the prior art including transom mounting, stern scissors- and retraction-mounts, as well as hollow thru-hull fittings with retractable sensors 332. The acoustic sensors 332 may be monostatic (single transmit/receive) or bi- and multi-static (source and receiver(s) are separated). Source transmit may be all-at-once wide-angle illumination, and/or directed single narrow-angle beam. Receive is performed by a phased array of elements so that detection and tracking may be performed in 2D (range, azimuth), or in azimuth and elevation for a higher cost 3D system (range, azimuth, elevation).

According to some embodiments, in the up-Doppler data (which slightly overlaps zero Doppler) perform target tracking from ping-to-ping. Estimate fish trajectory, speed, body flexure (wiggle) rate (e.g., how fish 310 propel themselves), and body aspect versus time with respect to sonar. Using reference acoustic target echoes on dredge 308, estimate target strength (TS) of fish 310 versus time-varying body aspect so that broadside max fish TS and length may be estimated. Using very wideband up-Doppler echo data, perform range compression to extract fish cardinal anatomical features from principal echo envelope versus time. This may help species ID.

Biologic tissue is more non-linear than water, so nonlinear acoustic imaging can be useful in a marine environment. The method was pioneered in ultrasonic medical imaging in the 1990s but it relied on nonlinear path propagation. In marine acoustics the propagation path is still present, but the target is even more nonlinear than the water. This offers enhancements to the TS at a number of frequencies. In this case, time-varying broadband waveforms are used to reduce the likelihood that a fish echo may have a beam pattern null in the echo direction.

Some embodiments may use simultaneous (broadband) waveform transmit at frequencies f₁ and f₂ to exploit nonlinearity
Low intensity sound case: simultaneous dual frequency pulse upsweep for f₁(t) and down-sweep for f₂(t) gives TS that may vary with time and frequency so less likely to sit in a null.
Higher intensity sound case: get the above plus four waveforms: f₁, f₂, |f₂−f₁|, and f₂+f₁, as well as harmonics 2f₁and 2f₂.
   Frequency band filtering allows the detection and exploitation of these separately, as well as the potential for data fusion of the results in each band.

Range Doppler Filtering:

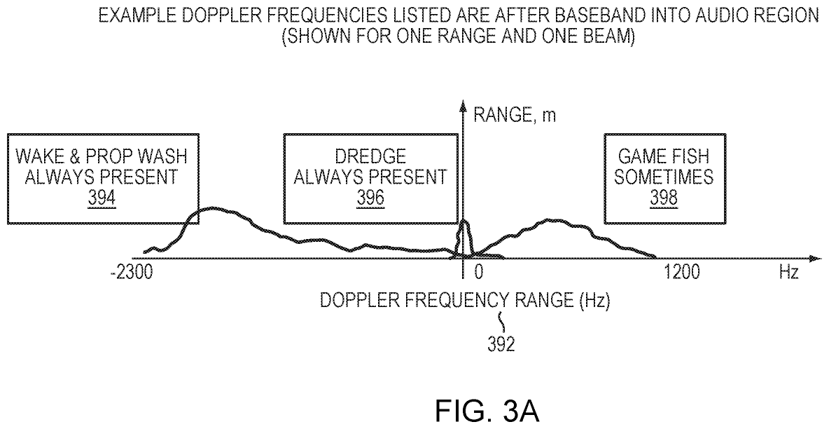

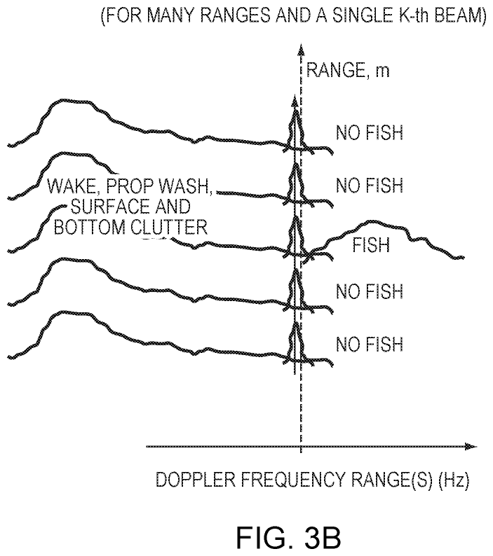

According to some embodiments, and as illustrated collectively in FIGS. 3A-6 to follow, Range Doppler filtering may be applied to perform an analysis on the received echoes. In some embodiments, for an azimuth beam, and range bins where a fish target (element 310 of FIG. 2B) may appear to be detected (using the pulse compression signal path), the method (and system) may receive the corresponding non-compressed data for the same azimuth beam (element 386 of FIG. 2B), and perform a fast-fourier-transform (FFT) a windowed portion that is centered about the time index for which a peak occurs in the pulse compression signal path. Other embodiments may use compressed data (as opposed to non-compressed data mentioned above).

The resulting FFT data may generally fall into one of the following three regions, as illustrated in FIG. 3A. FIG. 3A is a graph of range Doppler filtering, according to some embodiments of the present disclosure. Although FIG. 3A illustrates a frequency range of −2300 to 1200 Hz (reference element 392), the present disclosure is not so limited.

1. Down Doppler clutter (FIG. 3A, element 394, including but not limited to echoes for prop wash, engine exhaust, boat wake, bottom, as known to those skilled in the art). These echoes may occur at frequencies less than those transmitted by the sonar.

2. Zero Doppler (FIG. 3A, element 396, dredge and/or artificial acoustic reference target echoes, as known to those skilled in the art)

3. Up Doppler (FIG. 3A, element 398, attacking game fish echoes)

In addition, FIG. 3B is a graph of range Doppler filtering that corresponds to FIG. 3A, according to some embodiments of the present disclosure, but for many ranges and a single K-th beam.

Range Doppler Filtering—Doppler Processing:

Doppler processing may be implemented using audio band hardware and/or signal processing. Some embodiments may implement Doppler processing using one or more of the approaches to follow. In the approaches to follow, the Doppler frequencies listed below are preferably after baseband into audio region.

1. Attacking Game Fish, also few, in discrete range bins, up Doppler:

For an attacking game fish, with V=+2.57 to 6 m/s (or larger), f_{Doppler shift}=fₒ(1+V/ĉ)(1+V/ĉ)−fₒ=0 to +1200 Hz (or larger) (Doppler shift could be 0 Hz to 1200 Hz or higher depending on radial velocity of game fish), where V=separation_speed=|V_{fish}|−|V_{dredge}|=|V_{fish}|−|V_{boat}| because V_{boat}=V_{dredge}.

2. Gas bubbles and/or turbulence from prop wash and boat wake, and bottom echoes moving away from boat, occurs in many range bins, down Doppler:

For a gas bubble, the Doppler frequency shift is: fₒ(1−V/ĉ)(1−V/ĉ)−fₒ≈−2fₒV/ĉ=−682 Hz to −2300 Hz or larger Doppler shift is negative with forced prop convection. V=separation_speed=|V_{boat}|+|V_{wake}|.

Dredge targets are few, they occur in discrete range bins with very little change unless the dredge is moved; has approximately zero Doppler:

Zero Doppler because the distance to/from the dredge and boat is almost constant (i.e., no significant Doppler shift).

Next, FIGS. 4-6 are sequential flow diagrams, illustrating an example method (or system), according to some embodiments of the present disclosure.

As illustrated in FIG. 4, K acoustic beams 472 may be generated using one or more beamforming techniques known to one skilled in the art. In turn, some embodiments may determine and generate detection zones DZ from pulse compressed beams 402 a result 406 that may include a compressed version of the corresponding acoustic pulse, detection zones, and/or a signal-to-noise-range (SNR) estimate. As illustrated in FIG. 4, some embodiments may perform pulse compression 410 on the time series of the K acoustic beams, and the compressed pulses 416 may include both signal and noise elements. As illustrated in FIG. 4, a noise estimate 434 may be determined 430 based upon the compressed pulses 416 and one or more pulse parameters and/or window tapers 420 which may be provided by computer control 424. As illustrated in FIG. 4, the determined noise estimate 434 may be determined 430 over multiple pulses and may include, but is not limited to including, average, median, pseudo-median, and/or other statistics known to those skilled in the art.

As further illustrated in FIG. 4, a time varied gain 446 may be determined 440 based upon the compressed pulse 416 and the noise estimate 434, and may be displayed 450 to a display screen and/or one or more users. According to some embodiments the Time Varied Gain may be calculated as follows:

Time Varied Gain=20 log₁₀(voltage)+40 log₁₀(R)+2 αR where voltage is measured by the beamformer, R is range, and a is the absorption coefficient of sound.

As illustrated in FIG. 4, detection 460 may be performed above a noise threshold based upon the signal excess margin 454 (which may be controlled by a computer 458), compressed signal 416, and noise estimate 434. As also illustrated in FIG. 4, one or more detection zones DZ may be determined 406 based upon the detection 460 above the noise threshold.

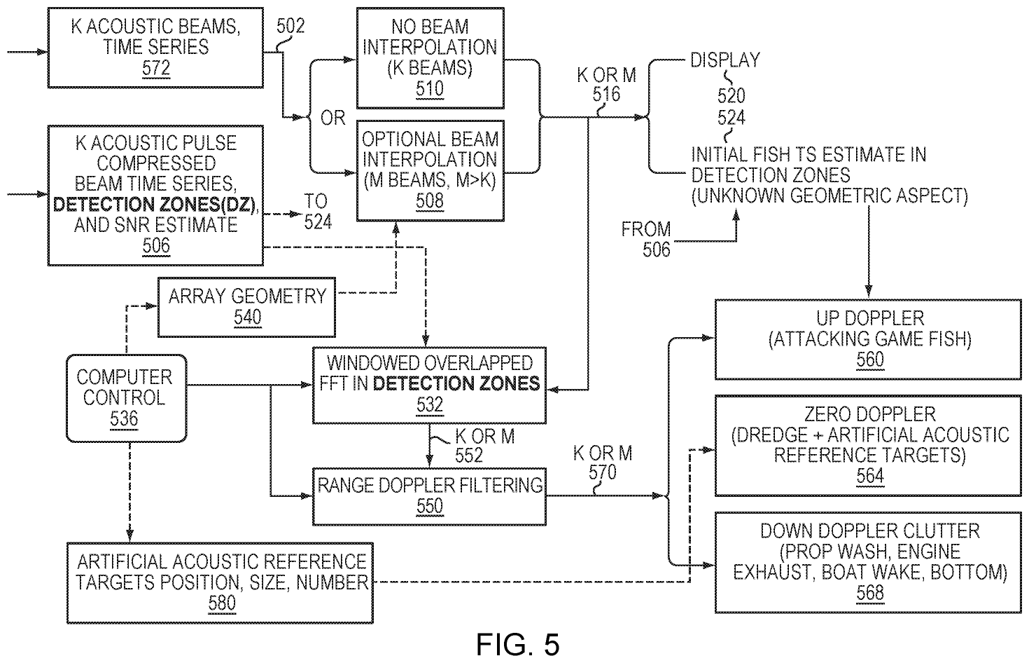

FIG. 5 represents another flow diagram, illustrating an example method (or system), according to some embodiments of the present disclosure and continues from the products 406 and 472 shown on FIG. 4. According to some embodiments, as illustrated in FIG. 5, K acoustic beams (time series) 572 and K acoustic pulse compressed beam time series, detection zones, DZ and SNR estimate 506 may be received. In some embodiments, the K acoustic beams (time series) 572 and K acoustic pulse compressed beam time series, detection zones, DZ and SNR estimate 506 may correspond to (and be provided by) elements 472, 406, respectively of FIG. 4.

As illustrated in FIG. 5, some embodiments may choose 502 beam interpolation 508 of M beams, where the number M is greater than the number K of acoustic beams 572. However, some embodiments may choose 502 not to perform 510 beam interpolation. Beam interpolation 508 may be based upon array geometry 540 which may be computer controlled 536. The resulting acoustic beams 516 (which may be interpolated 508 or not interpolated 510) may be forwarded to a display 520. Also, the resulting acoustic beams 516 together with detection zone DZ 506 may provide 524 as an Initial Fish TS estimate in detection zones (which may have an unknown geometric aspect) into the determination of Up Doppler (i.e., for attacking game fish) 560.

As further illustrated in FIG. 5, a windowed overlapped fast fourier transform (FFT) may be performed 532 on the based upon the K or M acoustic pulse compressed beam time series, detection zones, and SNR estimate 506, computer control 536 and the resulting acoustic beams 516. In turn, Range Doppler Filtering 550 may be performed based upon computer control 536 and the resulting windowed overlapped FFT in the detection zones 552.

Next, one of three Doppler shift results, including but not limited to an Up Doppler shift 560, Zero Doppler shift 564, or Down Doppler shift 568 may be determined based upon the result 570 of Range Doppler Filtering. In addition, Up Doppler 560 is found from 570, and may use the Initial Fish TS estimate 524. Further, Zero Doppler 564 may also be determined from 570 and based upon a number, position, or size of artificial acoustic reference targets (also referred to as “target objects” herein) 580 that may be based upon computer control 536.

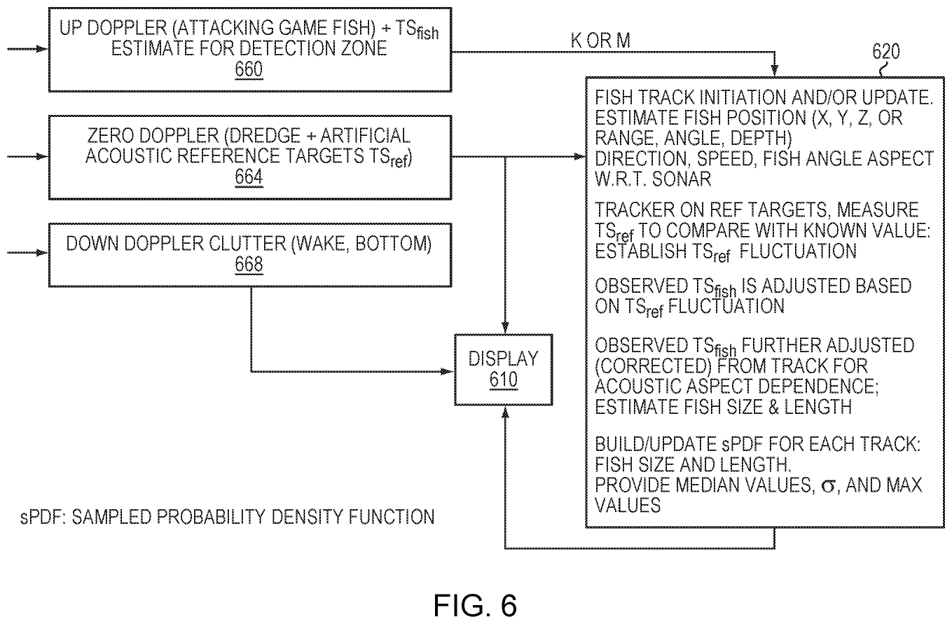

FIG. 6 represents another flow diagram, illustrating an example method (or system), according to some embodiments of the present disclosure. According to some embodiments, as illustrated in FIG. 6, Up Doppler 660, Zero Doppler 664, and Down Doppler 668 may be received. In some embodiments, the Up Doppler 660, Zero Doppler 664, and Down Doppler 668 may correspond to (and be provided by) elements 560, 564, 568, respectively of FIG. 5.

As illustrated in FIG. 6, the Up Doppler 660, Zero Doppler 664, and Down Doppler 668 results may be displayed 610 to a user. In some embodiments, an analysis 620 may be performed on the Up Doppler results prior to display 610.

As illustrated in FIG. 6, the analysis 620 may include but is not limited to one or more of the following steps, which are described in an order below, but are not limited to such an order. First, fish (target object) track initiation and/or update may be performed, which may include localizing, in which fish position or location is estimated (x, y, z or range, angle, depth), direction, speed, and/or fish angle aspect with respect to sonar. Next, tracking may be performed on the reference targets (reference objects), and a target strength TS_{ref} may be measured in order to compare with a known value in order to establish TS_{ref} fluctuation. Next, the observed TS_{fish} may be adjusted based on TS_{ref} fluctuation. Next, the observed TS_{fish} may be further adjusted (corrected) from track for acoustic aspect dependence. The adjustment may include estimation of fish (target object) size (e.g., sizing) and length. Finally the sampled Probability Density Function (sPDF) may be constructed or updated for each track based upon fish (target object) size and length, thereby providing median values, a (absorption coefficient) and/or maximum values, and thereby determining the size of (sizing) and type of (classifying) the fish.

Reference Acoustic Targets:

As illustrated in FIG. 6, the analysis 620 may optionally include one or more of acoustic detection, localizing, tracking, and sizing of at least one of the one or more physical objects. The one or more physical objects may include a plurality of physical objects including one or more target objects and one or more reference objects. The analysis may include one or more of acoustic detection, localizing, tracking, and sizing of at least one of the one or more target objects.

Some embodiments may employ one or more of the following features and/or considerations (and/or method steps and/or system components) in implementation of acoustic detection, localizing, tracking, and sizing of reference objects and/or target objects:

First, power amplifier behavior may be approximately known but not precisely (nominally to within 0.5 dB, or +/−5%). The amp may provide a powerful waveform to the sonar transducer array assembly. Transducer transmit response (TX) and receive response (RX) may also be approximately known, but may vary within as much as 3 dB for combined TX and RX values, especially from sample to sample. Careful calibration measurements can be made, but these may be costly and time consuming. These two things may place an uncertainty in the absolute acoustic echo level from a fish that can vary within 3-4 dB, assuming everything else is ideal and the fish is motionless.

Micro-multipath from the sonar, to the fish, and back can also cause weak fluctuations in the absolute acoustic echo level from 0.25 to 3 dB depending on water vorticity, unsteady water temperature, travel distance, and air bubbles. This is observed as very minor time-varying fading, so in the ocean it can be more of a problem. For these combined reasons, one or more reference acoustic targets (including but not limited to reference objects) may be affixed to the dredge.

The reference acoustic targets (including but not limited to reference objects) may be constructed of acoustic reflecting materials, such as air-filled plastics or metals, and of specific sizes so that they have a priori known acoustic targets strengths. The reference acoustic targets may be optionally coated for water intrusion resistance and drag reduction, and weighted to make them neutrally-buoyant when affixed to the dredge, and often disguised as lures.

According to some embodiments, for non-limiting example, an air-filled ping pong game ball may have a theoretical TS of −40 dB for α>>λ, where αis 19.5 mm radius, λ is the acoustic wavelength (λ=c/f), c is the sound speed and f is acoustic frequency. Spherical, partial-spherical, or hemispherical shapes may be well suited for use because the TS is approximately independent of the incident angle from the boat-mounted sonar.

An echo from the reference target has an echo voltage (EV) value, in dB re μPa, from the sonar equation:

EV=TVR+20 log₁₀(V)−40 log10(R)−2αR+TSₘₑₐₛ+RVR

TVR and RVS may be approximately known because they are characteristics of the sonar transducer, and V is the drive voltage from the amplifier. One-way range R is known from the two-way time of flight At and the sound speed c, R=c*Δt/2. Spherical spreading occurs twice, at 20 log₁₀ (R) for each of the outgoing and echo directions. Water temperature may be precisely measured, and the sound speed may be accurately calculated from it. The absorption coefficient a may be known from accurate math models for acoustic loss, because the acoustic frequency f may be known. EV may be measured by signal processing, after adjusting for any gains in the preamp.

Because EV may be now known, the measured target strength, i.e. TSₘₑₐₛ, may be evaluated by manipulation and substitutions into the sonar equation:

TSₘₑₐₛ=EV−TVR−RVR−20 log₁₀(V)+40 log10(R)+2αR

Since TS_{known} may be available a priori, this may lead to a correction:

Correction_dB=TS_{known}−TSₘₑₐₛ

This correction may compensates for the combined system unknowns (transducer, amp, propagation) and may then be applied to the received time series, thereby providing an initial correction to any observed fish target strength, TS_{fish}. This does not provide a complete correction to the TS_{fish} because the aspect dependence of the one or more fish (one or more target objects) with respect to the sonar may not be performed. For that correction to be made, the fish (target objects) are preferably tracked over time, over a number of j pings in FIG. 2A, and therefore over many pulses, as the fish (target objects) approach the dredge.

Fish TS: Aspect Dependence

Acoustic echoes from fish may be complex, because the fish (target objects) may have many scattering materials (tissue, cartilage, air bladders, bones) and many more geometric shapes.

Fish also may change their shape as they propel themselves, so the acoustic scattering geometry may vary during motion. Finally the incident direction (azimuthal and depression/elevation angles) and the frequency of the sound may further complicate the echo creation.

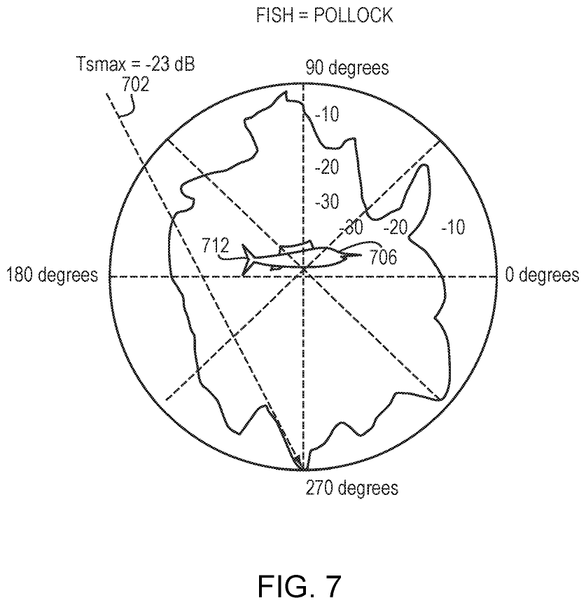

For the most part, fish echoes are strongest from the side, broadside, or lateral directions and smallest from either the front (anterior) or the back (posterior) directions. Schematically, the fish nose 706 points at 0° and the tail 712 points at 180° in a dorsal-ventral midsagittal plane of a TS plot, as illustrated in FIG. 7. As illustrated in FIG. 7, the TS peak may occur at 270° in the ventral direction, and the nose 706 and tail 712 may be approximately −13 dB to the TS relative 0 dB peak.

According to some embodiments, the reference “Modeling the detection range of fish by echolocating bottlenose dolphins and harbor porpoises,” J. Acoust. Soc. Am 121 (6), June 2007 (incorporated herein by reference in its entirety) provides additional examples of Aspect dependence, in which the max TS is shown as 0 dB relative in each polar plot.

The reference “Discriminating Chinook salmon by echolocating orca,” J. Acoust. Soc. Am 128 (4), 2225-2232 (2010) (incorporated herein by reference in its entirety) provides further background regarding corresponding echo waveforms and polargrams as a function of both frequency and angle.

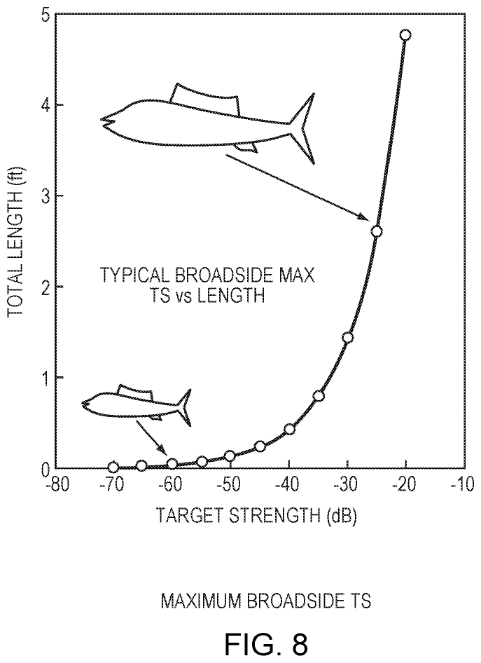

In addition, according to some embodiments, FIG. 8 illustrates a corresponding maximum broadside target strength (TS). As illustrated in FIG. 8, since frontal TS will be −10 to −15dB (from previous slide) with respect to these maximum TS values, from a frontal TS echo viewpoint (from the boat), one or more of the following results may be expected:

1. The max TS of small fish 390 is −40 dB or smaller. These fish are considered bait-size (or bite size) fish 390 and undetected unless in a school.

2. A 1 ft (0.3048 m) fish (−32 dB max TS, −42 to −47 dB frontal) may be at the edge of detection.

3. Large fish (predators) max TS to be −25 or larger.

4. So we need to detect −35 to −40 dB, or greater, looking aft from the boat for −20 to −25 dB game fish.

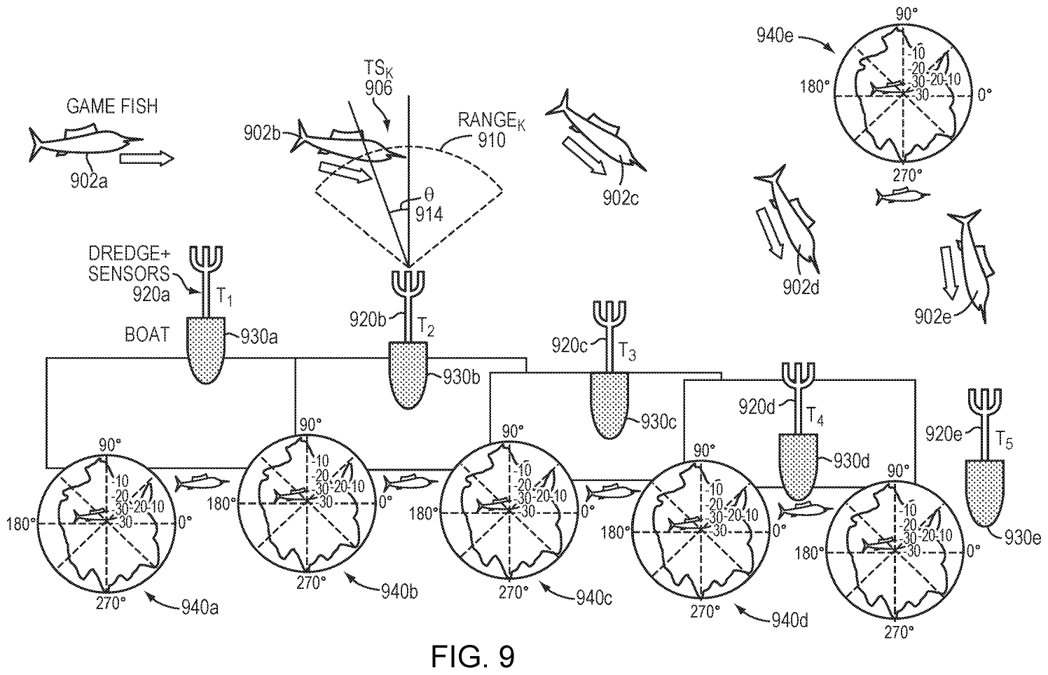

FIG. 9 illustrates the time evolution of a game fish (target object) having various positions (distances, 902a, 902b, 902c, 902d, 902e) with respect to a dredge with sensors (see elements 920a, 920b, 920c, 920d, 920e, respectively) that are connected to a boat (see elements 930a, 930b, 930c, 930d, 930e, respectively), and the resulting target strength (TS) plots 940a, 940b, 940c, 940d, 940e as the fish sees the dredge lures, changes course, and then approaches and attacks the dredge. As illustrated in FIG. 9, some embodiments detect target strength 906 with respect to a range 910 and angle 914 between the dredge 920b and target object 9902b. As illustrated in FIG. 9, game fish may include sail fish.

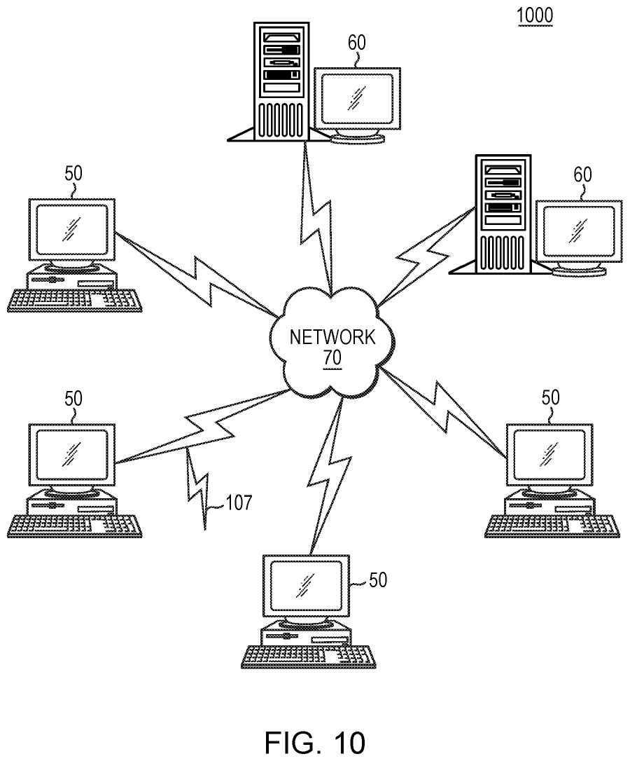

FIG. 10 illustrates a computer network (or system) 1000 or similar digital processing environment, according to some embodiments of the present disclosure. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

Client computers/devices 50 may be configured with a computing module (located at one or more of elements 50, 60, and/or 70). In some embodiments, a user may access the computing module executing on the server computers 60 from a user device, such a mobile device, a personal computer, or any computing device known to one skilled in the art without limitation. According to some embodiments, the client devices 50 and server computers 60 may be distributed across a computing module.

Server computers 60 may be configured as the computing modules which communicate with client devices 50 for providing access to (and/or accessing) databases that include data associated with target objects and/or reference objects. The server computers 60 may not be separate server computers but part of cloud network 70. In some embodiments, the server computer (e.g., computing module) may enable users to determine location, size, or number of physical objects (including but not limited to target objects and/or reference objects) by allowing access to data located on the client 50, server 60, or network 70 (e.g., global computer network). The client (configuration module) 50 may communicate data representing the physical objects back to and/or from the server (computing module) 60. In some embodiments, the client 50 may include client applications or components executing on the client 50 for determining location, size, or number of physical objects, and the client 50 may communicate corresponding data to the server (e.g., computing module) 60.

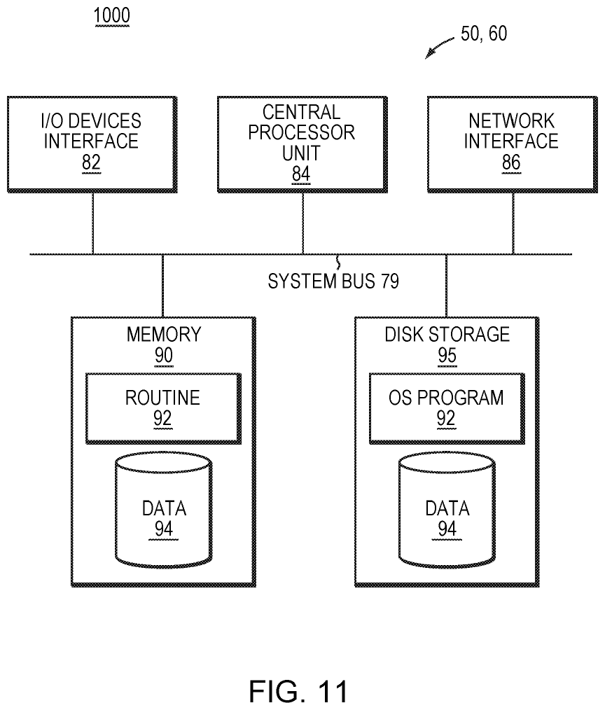

Some embodiments of the system 1000 may include a computer system for determining location, size, or number of physical objects. The system 1000 may include a plurality of processors 84. The system 1000 may also include a memory 90. The memory 90 may include: (i) computer code instructions stored thereon; and/or (ii) data representing location, size, or number of physical objects. The data may include segments including portions of the location, size, or number of physical objects. The memory 90 may be operatively coupled to the plurality of processors 84 such that, when executed by the plurality of processors 84, the computer code instructions may cause the computer system 1000 to implement a computing module (the computing module being located on, in, or implemented by any of elements 50, 60, 70 of FIG. 10 or elements 82, 84, 86, 90, 92, 94, 95 of FIG. 11) configured to perform one or more functions.

According to some embodiments, FIG. 11 is a diagram of an example internal structure of a computer (e.g., client processor/device 50 or server computers 60) in the computer system 1000 of FIG. 10. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 10). Memory 90 provides volatile storage for computer software instructions 92 and data 94 used to implement some embodiments (e.g., multiuser site, configuration module, and/or administration module engine elements described herein). Disk storage 95 provides non-volatile storage for computer software instructions 92 and data 94 used to implement an embodiment of the present disclosure. A central processor unit 84 is also attached to the system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the present disclosure. The computer program product 92 can be installed by any suitable software installation procedure, as is well known in the art. In another embodiment, at least a portion of the software instructions may also be downloaded over a cable, communication and/or wireless connection. Other embodiments may include a computer program propagated signal product 107 (of FIG. 11) embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the routines/program 92 of the present disclosure.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

Some embodiments are successfully tested and capable of various results. As such, some embodiments are capable of handling Background Acoustic Clutter from Boat Prop Wash using a transducer.

In some embodiments, the following are included: (1) Grayscale map at 4 knots (2) Vessel looking aft approximately 200 ft (61 m), (3) approximately 90° sector view, and (4) no dredge.

In some embodiments, the transducer is pointed aft using narrow vertical beam(8°) but sidelobes intercept engine prop wash, so acoustic scattering is most visible in an image center. Some embodiments provide a vertical beam coverage wide enough to see the dredge and attacking gamefish, but narrow enough to not see the prop wash or surface clutter echoes. In some embodiments, downward pitch angle helps limit prop wash echoes and surface clutter at the expense of dredge acoustic coverage.

In some embodiments, a low-sidelobe 18° vertical beamwidth transducer acoustic image may show reduced engine prop wash, so acoustic scattering may be weakly visible in an image center. Some embodiments enable excellent wide vertical coverage with minimal prop wash and surface clutter.

Some embodiments may include weak intermittent surface clutter.

In some embodiments, the following are included: (1) Grayscale map at 4 knots (2) Vessel looking aft approximately 200 ft (61 m), (3) approximately 90° sector view, and (4) dredge with acoustic targets.

In an embodiment, a low-sidelobe 18° vertical beamwidth transducer acoustic image shows persistent (from frame to frame) strong acoustic target within a dashed ellipse in a display. Some embodiments may include a photo inset: a pre-deployment dredge with lures and acoustic targets.

Embodiments or aspects thereof may be implemented in the form of hardware (including but not limited to hardware circuitry), firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this disclosure has been particularly shown and described with references to example embodiments thereof, it will be understood by those skilled in the art that various changes in form and details may be made therein without departing from the scope of the disclosure encompassed by the appended claims.

What is claimed is:

1. A method comprising:
generating, from an aft direction of a marine vessel, one or more pulses of sound;
receiving, at the aft direction of a marine vessel, one or more echoes, in response to the generated one or more pulses of sound interacting with one or more physical objects; and
performing an analysis on the received one or more echoes based upon the generated one or more pulses of sound, the analysis being performed based upon space-time Doppler filtering to detect range and direction of at least one of the one or more physical objects.

2. The method of claim 1, wherein the one or more physical objects include at least one of (i) game fish and (ii) a plurality of physical objects including one or more target objects and one or more reference objects.

3. The method of claim 1, wherein the analysis is based upon at least one of the size and location of at least one of the one or more physical objects.

4. The method of claim 1, wherein the analysis includes one or more of acoustic detection, localizing, tracking, and sizing of at least one of the one or more physical objects.

5. The method of claim 1, wherein the analysis is based upon estimating depth of at least one of the one or more physical objects.

6. The method of claim 1, further comprising displaying live video of at least one of the one or more physical objects.

7. The method of claim 1, further comprising displaying at least one of depth and temperature of a dredge attached to the marine vessel.

8. The method of claim 1, further comprising performing the generating of the one or more pulses of sound from at least one of below and astride the marine vessel.

9. The method of claim 1, further comprising performing the generating of the one or more pulses of sound from first and second sound sources, the second sound source being connected to a dredge connected to the marine vessel.

10. A system comprising:
at least one processor coupled to associated memory, the at least one processor configured to implement:
a generation module configured to generate, from an aft direction of a marine vessel, one or more pulses of sound;
a receiving module configured to receive, at the aft direction of a marine vessel, one or more echoes, in response to the generated one or more pulses of sound interacting with one or more physical objects; and
a processing module, configured to perform an analysis on the received one or more echoes based upon the generated one or more pulses of sound, the analysis being performed based upon space-time Doppler filtering to detect range and direction of at least one of the one or more physical objects.

11. The system of claim 10, wherein the one or more physical objects include at least one of (i) game fish and (ii) a plurality of physical objects including one or more target objects and one or more reference objects.

12. The system of claim 10, wherein the analysis is based upon at least one of the size and location of at least one of the one or more physical objects.

13. The system of claim 10, wherein the analysis includes one or more of acoustic detection, localizing, tracking, and sizing of at least one of the one or more physical objects.

14. The system of claim 10, wherein the analysis is based upon estimating depth of at least one of the one or more physical objects.

15. The system of claim 10, further comprising a generation module configured to display live video of at least one of the one or more physical objects.

16. The system of claim 10, further comprising a generation module configured to display at least one of depth and temperature of a dredge attached to the marine vessel.

17. The system of claim 10, wherein the generation module is further configured to generate the one or more pulses of sound from at least one of below and astride the marine vessel.

18. The system of claim 10, wherein the generation module is further configured to generate the one or more pulses of sound from first and second sound sources, the second sound source being connected to a dredge connected to the marine vessel.
